(19) United States
(12) Patent Application Publication
(10) Pub. No.: US 2026/0286148 A1
(43) Pub. Date: Sep. 24, 2026

(54) MATTING COATING COMPOSITION, MATTING OBJECT AND MANUFACTURING METHOD THEREOF

(71) Applicant: ASUSTeK COMPUTER INC., Taipei City (TW)

(72) Inventors: Yi-Chuan Li, Taipei City (TW); Ming-Chung Cheng, Taipei City (TW); Ching-Yang Lee, Taipei City (TW); Chin-Hsiang Chang, Taipei City (TW); Yi-Shiau Liau, Taipei City (TW); Kai-Wen Jeng, Taipei City (TW); Hua-Kuo Chin, Taipei City (TW); Chian-Shiuan Lin, Taipei City (TW); Yi-Ting Lin, Taipei City (TW); Wei-Ning Chen, Taipei City (TW); Yu-Chun Hou, Taipei City (TW)

(73) Assignee: ASUSTeK COMPUTER INC., Taipei City (TW)

(21) Appl. No.: 19/201,892

(22) Filed: May 7, 2025

(30) Foreign Application Priority Data
Mar. 18, 2025 (TW) 114110008

(51) Int. Cl. C09D 7/42; C09D 7/20; C09D 7/65; C09D 133/04

(52) U.S. Cl. CPC C09D 7/42; C09D 7/20; C09D 7/65; C09D 133/04

(57) ABSTRACT

A matting coating composition includes acrylic resin, solvent, retarder, and matting agent, in which based on 100 parts by weight of the matting coating composition, the acrylic resin accounts for 45 wt % to 60 wt %; the solvent accounts for 3 wt % to 17 wt %; the retarder accounts for 1 wt % to 8 wt %; and the matting agent is less than or approximately equal to 5 wt %.

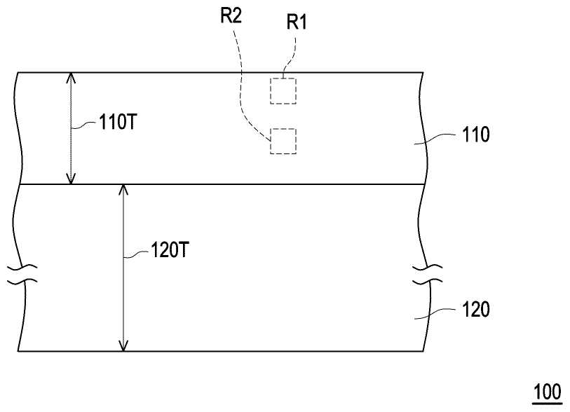

### CROSS-REFERENCE TO RELATED APPLICATION

This application claims the priority benefit of Taiwan application serial no. 114110008 filed on Mar. 18, 2025. The entirety of the above-mentioned patent application is hereby incorporated by reference herein and made a part of this specification.

### BACKGROUND

### Technical Field

The disclosure relates to a coating, an object, and a manufacturing method thereof, and particularly relates to a matting coating composition, a matting object, and a manufacturing method thereof.

### Related Art

In conventional handheld or touch electronic devices (such as laptops, mobile phones, keyboards, mice), for appearance or durability design, multiple different coating layers are usually coated on the outer surface of the object. For example: first, a colored coating layer is coated, and then a protective layer is coated on the colored coating layer.

However, the above conventional method may cause product price increase, environmental pollution increase, energy consumption rise, and/or production flexibility decrease. For example, since multiple coating layers need to be added, factors such as the materials used (such as coatings, solvents), labor, and machine hours may all increase by multiples. For another example, the process of multiple coating layers may also cause an increase in the emission of volatile gases (such as solvents), remaining materials, or waste, as well as increased use of water, electricity, gas, and other energy resources. For still another example, the process of multiple coating layers may lead to a decrease in overall production flexibility, making product control potentially more difficult (such as peeling between different coating layers), resulting in a decrease in overall yield or production rate (such as throughput).

Based on the above, with the demands of the overall market and environment, using more environmentally friendly, economical, and flexible methods to solve the aforementioned problems has indeed become a focus of research and development.

### SUMMARY

The disclosure provides a matting coating composition, a matting object, and a manufacturing method thereof, which has a simpler application process, and the corresponding object may have better matting properties.

The matting coating composition of the disclosure includes acrylic resin, solvent, retarder, and matting agent. Based on 100 parts by weight of the matting coating composition, the acrylic resin accounts for 45 wt % to 60 wt %; the solvent accounts for 3 wt % to 17 wt %; the retarder accounts for 1 wt % to 8 wt %; and the matting agent is less than or approximately equal to 5 wt %.

The manufacturing method of the matting object of the disclosure includes the following. The matting coating composition is coated on an object. The matting coating composition coated on the object is cured to form a matting coating layer on the object. The matting coating composition includes acrylic resin, solvent, retarder, and matting agent. Based on 100 parts by weight of the matting coating composition, the acrylic resin accounts for 45 wt % to 60 wt %; the solvent accounts for 3 wt % to 17 wt %; the retarder accounts for 1 wt % to 8 wt %; and the matting agent is less than or approximately equal to 5 wt %.

The matting object of the disclosure includes an object and a matting coating layer. The matting coating layer directly covers the object. The matting coating layer is formed by the matting coating composition. The matting coating composition includes acrylic resin, solvent, retarder, and matting agent. Based on 100 parts by weight of the matting coating composition, the acrylic resin accounts for 45 wt % to 60 wt %; the solvent accounts for 3 wt % to 17 wt %; the retarder accounts for 1 wt % to 8 wt %; and the matting agent is less than or approximately equal to 5 wt %.

Based on the above, since the matting coating composition includes appropriate compositions and corresponding ratios as previously described, the disclosure is made to have a simpler application process, and the corresponding object may have better matting properties.

### BRIEF DESCRIPTION OF THE DRAWINGS

FIGURE is a cross-sectional schematic view of a matting object according to an embodiment of the disclosure.

### DESCRIPTION OF THE EMBODIMENTS

In this document, non-limiting terms (such as possibly, may, for example, or other similar terms) are non-essential or optional implementations, inclusions, additions, or presences.

In this document, unless otherwise specified, when using the antecedent “approximately” to express a value, it may directly represent that specific value. Also, when using the antecedent “approximately” to express that value, it may include the range of measurement errors that can be included in general measurement methods (such as within ±3%; preferably: within ±1%) or the range of error propagation after derivation or calculation based thereon.

In this document, when using the antecedent “approximately” to express a value, it may also directly represent that specific value, meaning the word “approximately” may be omitted. A range in this document may be expressed as from “approximately” one specific value to “approximately” another specific value, and at least one of the “approximately” words may also be omitted; such as, directly expressing from one specific value to another specific value.

### Composition of the Matting Coating Composition

Based on one 100 parts by weight of the matting coating composition, the matting coating composition may include the following compositions, 45 parts by weight (wt %) to 60 wt % of acrylic resin, 3 wt % to 17 wt % of solvent, and 1 wt % to 8 wt % of retarder.

The solvent may include ester solvents, ketone solvents, or co-solvents of the above-mentioned solvents. Ester solvents include, for example, ethyl acetate (EA). Ketone solvents include, for example, methyl isobutyl ketone (MIBK). For example, based on 100 parts by weight of the matting coating composition, the ester solvent (such as ethyl acetate) may be 4 wt % to 10 wt %; and/or, the ketone solvent (such as methyl isobutyl ketone) may be 3 wt % to 7 wt %.

The retarder may reduce the evaporation of the matting coating composition components (such as solvent), so that in the application of the matting coating composition, the corresponding flowability and/or leveling property may be enhanced. The retarder may include, for example, isobutyl isobutyrate (IBIB).

In one embodiment, the matting coating composition may further add appropriate optical additives. The addition of optical additives may provide the matting coating composition with appropriate color and/or gloss. For example, optical additives may include colorants and/or reflective materials. Based on 100 parts by weight of the matting coating composition, the optical additives may be less than or approximately equal to 8 wt %.

In one embodiment, the addition of colorants may provide the matting coating composition with appropriate color. Based on 100 parts by weight of the matting coating composition, the amount of colorant added may be less than or approximately equal to 5 wt %, such as 1 wt % to 5 wt %. The colorant may include inorganic colorants, organic colorants, or mixtures thereof. Taking as an example, the inorganic colorants may include, such as titanium dioxide particles (white), carbon black particles (black), but the disclosure is not limited thereto. Taking as an example, the organic colorants may include, such as azo compounds, phenolic compounds, but the disclosure is not limited thereto.

In one embodiment, the addition of reflective materials may provide the matting coating composition with appropriate gloss. The reflective materials may include appropriate metal particles, such as aluminum paste including aluminum particles, silver powder. Based on 100 parts by weight of the matting coating composition, the amount of reflective material added may be less than or approximately equal to 3 wt %.

In one embodiment, the matting coating composition may further add appropriate matting agent. Based on 100 parts by weight of the matting coating composition, the amount of matting agent added may be less than or approximately equal to 5 wt %. The matting agent may be organic material, so that may have better mixing with the main components (that is, acrylic resin, solvent, and/or retarder) of the matting coating composition. For example, the matting agent may include micronized wax additive and/or micronized wax-like polymer, which may include, for example, particles made of polymethyl urea, polyethylene, mixtures thereof, or modified (such as oxidized) materials, in which the main particle size distribution (represented by 50% particle percentage, that is, d50) of the aforementioned particles may be in a range of 3 micrometers (μm) to 12 μm. Micronized wax is an organic material that may have better mixing with other components (such as acrylic resin, solvent, and/or retarder) after stirring, which may reduce the possibility of phase separation. Additionally, if the particle size of the particles is too small, then the effect produced visually may not be significant. Furthermore, if the particle size of the particles is too large, then it may affect visual appearance.

In one embodiment, the matting coating composition may further add other additives. Other additives may be appropriately added according to the requirements of the final product. For example, other additives may include but are not limited to leveling agents, anti-UV agents, adhesion promoters, fillers, and dispersants. Based on 100 parts by weight of the matting coating composition, other additives may be less than or approximately equal to 22 wt %, such as 15 wt % to 22 wt %. The ratio of other additives should not be too high (such as should not be greater than 30 wt %), so as to reduce the impact on the effect of the matting coating composition.

In one embodiment, when coating with the matting coating composition including a leveling agent, the leveling agent may reduce surface defects during the coating process or after coating, which may provide the product with better appearance effects and protection.

In one embodiment, after coating the product with the matting coating composition including an anti-ultraviolet agent, ultraviolet light damage to the product (such as fading or discoloration) or deterioration (such as surface photolysis or photo-degradation) may be reduced.

In one embodiment, after coating the product with the matting coating composition including adhesion additives, the adhesion between the matting coating composition and the coated object may be enhanced, which may reduce the possibility of peeling of the film layer formed by the matting coating composition after being coated, so that the product may have good appearance or quality.

In one embodiment, fillers are materials with low reactivity (that is, basically do not produce corresponding chemical reactions with other components in the matting coating composition) such as calcium carbonate powder, silicon dioxide powder, and mica powder. The addition of fillers may produce moderate synergistic effects with other components in the matting coating composition, which may appropriately adjust viscosity, hardness, or elasticity, or may reduce costs.

In one embodiment, dispersants may include corresponding surfactants, which may promote the separation of particle components in the matting coating composition, so as to enhance the uniformity of various components in the matting coating composition.

### Preparation of Matting Object and Matting Object

In one embodiment, the matting coating composition of the aforementioned embodiment may be coated on an object by flow coating, dip coating, spin coating, roll coating, curtain coating, and spray coating or other suitable methods. Then, the matting coating composition coated on the object is cured by appropriate methods to form a corresponding matting coating layer on the object, thereby forming a corresponding matting object. That is, the matting object includes the object and the matting coating layer on the object.

In one embodiment, the object coated with the matting coating composition may include plastic material, such as plastic housing. In one embodiment, the thickness (such as a thickness 120T in FIGURE) of the object is in millimeter (mm) scale, such as greater than or approximately equal to 1 mm.

In one embodiment, by using spray coating method, the matting coating composition coated on the object may have better uniformity and/or more consistent thickness. The equipment used for spray coating may include low-pressure high-atomization spray guns, pressure regulating valves, or multi-axis spray machines. Low-pressure high-atomization spray guns may be used to evenly disperse the coating, facilitating coating on the object surface. Pressure regulating valves may make the input pressure of the matting coating composition more stable, so as to reduce flow variations caused by pressure fluctuations. Multi-axis spray machines may make the thickness of the matting coating composition coated on the object more consistent.

In one embodiment, a thickness of the matting coating layer (such as a thickness 110T in FIGURE) may be approximately in a thickness range of 0.1 μm to 50 μm.

In one embodiment, the matting coating layer is a single film layer. In one embodiment, the matting coating layer is a single film layer with corresponding color. That is, the single matting coating layer directly covering the object is suitable to be touched (such as touched with fingers).

In one embodiment, the matting coating composition coated on the object may be cured by heating method. In one embodiment, “curing” may refer to at least a portion of coating components intended to be cured producing corresponding crosslinks. In one embodiment, the crosslink density (that is, degree of crosslinking) of the cured matting coating composition (that is, the matting coating layer) may be of 35% to 100% of complete crosslinking. The crosslink density (that is, degree of crosslinking) may be determined by Dynamic Mechanical Analysis (DMA) method, but the disclosure is not limited thereto.

In one embodiment, the heating method may be carried out by temperature-controlled heat exchange equipment with a Proportional-Integral-Derivative (PID) controller. After being modeled, the PID controller may effectively optimize parameters, thereby enhancing temperature stability. For example, the PID controller may first model the overall environment through predetermined parameters, and then during heating, through the position of temperature sensing points, air volume, air velocity, air direction, and/or the configuration of heaters (such as heat exchange lamps), good, uniform, or appropriate temperature or heating curve may be achieved.

In one embodiment, the heating temperature may be in a range of 40° C. to 80° C. By using the PID controller, the temperature difference (including but not limited to the temperature difference between the set temperature and the actual temperature; or, the temperature difference between the highest temperature and the lowest temperature in the heating zone) may be less than 3° C.

In one embodiment, by using the PID controller, multi-stage heating processes may be performed. For example, preliminary heating may be performed in one temperature range to achieve appropriate leveling condition; then, further heating may be performed in another temperature range to increase the curing rate (such as approaching or almost completely curing).

In one embodiment, the components and/or ratios of the matting coating composition used to prepare the matting coating layer may be adjusted within the range of the above embodiments according to appropriate applications. For example, the types and/or ratios of acrylic resin, solvent, and/or retarder may be selected based on testing or corresponding appearance requirements. Then, if necessary, the types and/or ratios of colorants added may be adjusted according to the required color (such as determined by the standard color card). Then, appropriate types and/or ratios of reflective materials, matting agent, and/or other additives may be added. Then, the formulated matting coating composition is coated on the object. If necessary, when the matting coating composition is coated on the object (not yet cured), whether the color, gloss, and/or thickness is appropriate may be confirmed first. Then, the matting coating composition coated on the object is cured. Since the crosslinking degree of the cured matting coating composition (that is, the matting coating layer) may affect the color, gloss, and/or thickness, if necessary, whether the color, gloss, and/or thickness of the matting coating layer is appropriate may be determined by appropriate methods (such as determined by the standard color card). Through one or more cycles of the above steps, the components and/or ratios of the matting coating composition may have appropriate formulation. Finally, after the color, gloss, and/or thickness of the matting coating layer meet expectations, friction tests may be performed on the matting coating layer of the matting object.

In one embodiment, the matting agent added to the matting coating composition includes micronized wax additive and/or micronized waxy polymer, and under the above curing conditions, since other materials in the matting coating composition different from the micronized wax additive/micronized waxy polymer may be more easily cured and thus closer to the object, the concentration of micronized wax additive/micronized waxy polymer is caused to be higher at locations farther from the object. Therefore, as shown in FIGURE, for a matting object 100 including an object 120 and a matting coating layer 110, although in terms of process, the matting coating layer 110 is a single film layer formed through a single coating process, for the cured matting coating layer 110, it may be distinguished in the thickness direction of the structure into a first portion R1 farther from the object 120 and a second portion R2 closer to the object 120, in which the concentration of micronized wax additive/micronized waxy polymer in the first portion R1 is greater than the concentration of micronized wax additive/micronized waxy polymer in the second portion R2. Additionally, since the micronized wax additive/micronized waxy polymer may aggregate or be located at the outermost surface (that is, the surface that may be touched by fingers), the overall matting property may also enhanced.

In one embodiment, the aforementioned friction test may be performed using felt to simulate the natural touch state of the human body. The felt, for example, includes wool felt suitable for general standards (such as ASTM D2475, but not limited thereto). The friction test using felt may be performed using commercially available test machines (such as Automatic Abrasion Tester, model PAT-2012 from PROYES INTERNATIONAL CORPORATION). For example, the level (such as level within a range of ±1°) of the test machine is first adjusted. Then, fit or fix the felt used for testing onto the fixture used for the test machine. The fixture may simulate the corresponding pressure of natural touch in subsequent tests by weight blocks (such as weights). Then, the matting object to be tested is placed at the testing position of the test machine. Afterward, after the matting object is placed, and the felt and corresponding fixture are prepared, the corresponding test using the felt is performed on the matting coating layer of the matting object. The test may include but is not limited to number of times (such as simulated touch times), speed (such as simulated touch speed), distance (such as simulated touch distance for each time or overall).

In one embodiment, under a weight of 500 grams (g), when the touch simulation using felt is performed 60000 times on the matting coating layer of the matting object, a gloss deviation of the matting coating layer of the matting object may be in a range of below 20%. The gloss deviation may be measured using a gloss meter, and measured in gloss unit and converted with angles (such as 20°, 60°, and 85°) commonly used for measurement, which is: (gloss unit before test—gloss unit after test)/gloss unit before test, and the relative absolute value may be taken.

In summary, the matting coating composition of the disclosure, due to including appropriate compositions (such as matting agent) and corresponding ratios as previously described, the disclosure is made to have a simpler application process, and the corresponding object may have better matting properties.

What is claimed is:

1. A matting coating composition, comprising:
an acrylic resin;
a solvent;
a retarder; and
a matting agent, wherein based on 100 parts by weight of the matting coating composition,
the acrylic resin accounts for 45 wt % to 60 wt %;
the solvent accounts for 3 wt % to 17 wt %;
the retarder accounts for 1 wt % to 8 wt %; and
the matting agent is less than or approximately equal to 5 wt %.

2. The matting coating composition as claimed in claim 1, wherein the solvent comprises 4 wt % to 10 wt % of an ester solvent and 3 wt % to 7 wt % of a ketone solvent.

3. The matting coating composition as claimed in claim 1, further comprising a micronized wax additive or a micronized wax-like polymer.

4. The matting coating composition as claimed in claim 1, wherein main particle size distribution of the matting agent is in a range of 3 μm to 12 μm.

5. The matting coating composition as claimed in claim 1, further comprising an optical additive less than or equal to 8 wt %.

6. A manufacturing method of a matting object, comprising:
coating a matting coating composition on an object; and
curing the matting coating composition coated on the object to form a matting coating layer on the object, wherein the matting coating composition comprises:
an acrylic resin;
a solvent;
a retarder; and
a matting agent, wherein based on 100 parts by weight of the matting coating composition:
the acrylic resin is 45 wt % to 60 wt %;
the solvent is 3 wt % to 17 wt %;
the retarder is 1 wt % to 8 wt %; and
the matting agent is less than or approximately equal to 5 wt %.

7. The manufacturing method of the matting object as claimed in claim 6, wherein the matting coating composition is coated on the object by using a spray coating method.

8. The manufacturing method of the matting object as claimed in claim 6, wherein the matting coating composition coated on the object is cured by heating in a range of 40° C. to 80° C.

9. A matting object, comprising:
an object; and
a matting coating layer directly covering the object, wherein the matting coating layer is formed by a matting coating composition, wherein the matting coating composition comprises:
an acrylic resin;
a solvent;
a retarder; and
a matting agent, wherein based on 100 parts by weight of the matting coating composition,
the acrylic resin accounts for 45 wt % to 60 wt %;
the solvent accounts for 3 wt % to 17 wt %;
the retarder accounts for 1 wt % to 8 wt %; and
the matting agent is less than or approximately equal to 5 wt %.

10. The matting object as claimed in claim 9, wherein under a weight of 500 grams, after 60000 touches with felt on the matting coating layer of the object, a gloss deviation of the matting coating layer is less than or equal to 20%.
